(19) United States
(12) Patent Application Publication
(10) Pub. No.: US 2006/0242163 A1
(43) Pub. Date: Oct. 26, 2006

(54) Local thumbnail cache

(75) Inventors: Marc Miller, Redmond, WA (US); Brenda A. Yanity, Renton, WA (US); David G. De Vorchik, Seattle, WA (US); Fabrice A. Debry, Bellevue, WA (US); Jeffrey C. Belt, Bellevue, WA (US); Manuel Millot, Bellevue, WA (US); Paul A. Gusmorino, Seattle, WA (US); Paul L. Cutsinger, Redmond, WA (US); Robert E. Sinclair, Sammamish, WA (US); Tyler K. Beam, Redmond, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/111,986

(22) Filed: Apr. 22, 2005

(51) Int. Cl. G06F 7/00

(52) U.S. Cl. 707/100

(57) ABSTRACT

Systems and methods are provided for storing and retrieving thumbnail images in a per-user/per-system thumbnail cache. One or more data files may be used to store thumbnail images of varying sizes. An index is updated with the location or locations of thumbnails for a particular file, the URL and modification time of which may be used as a key to finding the thumbnails within the index. Direct memory mapping of thumbnail images are provided. Concurrency techniques are utilized to maintain cooperative access to the cache among multiple processes. Cache contents which are orphaned or unused are reclaimed for use by newer or more frequently used thumbnail images.

### FIELD OF THE INVENTION

The invention relates to caching images on a computer. More particularly, the invention provides for caching images in a system-wide thumbnail image database.

### BACKGROUND OF THE INVENTION

Thumbnail images are a common scheme used on computers for conveying the contents of an image or file without actually having to open the image or file. A thumbnail may present miniaturized portraits of images, word processing documents, web pages, presentation slides, and so forth. Thumbnails are frequently used as icons to represent files in graphical operating systems.

FIG. 2A presents a prior art example of thumbnail usage in a graphical operating system. Window 201 displays thumbnail images of a collection of JPEG formatted files 202 contained in a common file directory. Each thumbnail image is a replica of the contents of the file, re-sized to fit a standard size. One file in particular is selected, and window 201 displays the thumbnail 203 of the selected file.

FIG. 2B presents a prior art example of thumbnail storage in a file hierarchy 205 available to computer 110. The files represented in file hierarchy 205 may be stored on computer 110 (e.g., on a hard drive or in dynamic memory), on removable media (e.g., on a floppy drive or a USB thumbdrive), on a network server, or in a location otherwise accessible to computer 110. Files within file hierarchy 205 may be stored in hierarchical fashion using a system of file folders, which contain files as well as other file folders. First file folder 211 stores a first collection of files 212, and second file folder 221 stores a second collection of files 222.

Using a conventional methodology, an operating system on computer 110 creates thumbnails of the files in file folders 211, 221. For example, to create the folder view of window 201, the operating system may create thumbnails of the files by iterating through each file, scanning its contents and generating a standard-sized replica of the contents. In some operating systems, this step may be repeated each time a particular set of thumbnails is needed. In other operating systems, the thumbnails are generated once and then may be stored as graphical files (e.g., bitmaps or jpegs) for later retrieval. Such a system saves processing time for future thumbnail retrieval. Computer 110 stores previously rendered thumbnails in thumbnail caches 214, 224.

First thumbnail cache 214 may contain thumbnails for each of the files in the first collection 212. Whenever called upon, first thumbnail cache 214 may offer up these images for use by either the operating system, or a third party piece of software. Likewise, second thumbnail cache 224 may offer up the images from the second collection 222 on demand. Storing thumbnails in this folder-by-folder fashion, while straightforward, can create problems for a user of computer 110.

Using present methodologies, computer 110 is only able to store generated thumbnails in file folders for which it has write access. If, for example, a user of computer 110 browses images stored on a read-only CD-ROM, the generated thumbnails cannot be stored for future reuse, since the operating system cannot create a thumbnail cache in file folders stored on the CD-ROM. In addition, with present methodologies, secure access to sensitive files may be compromised. For example, if the owner of slide presentation 223 made the file inaccessible to any other user of computer 110, another user may still be able to view the thumbnail generated by the operating system and stored in second thumbnail cache 224. Although it is only a miniaturized version of a presentation slide, the thumbnail may still be enough to disclose sensitive information. As thumbnail images grow in size and detail, such security issues may become more of a concern.

Prior thumbnail systems allowed multiple copies of thumbnail images to be created in memory as thumbnail contents are duplicated for display, utilizing more memory than necessary. Also, disparately stored thumbnail caches prevent intelligent pruning of less-used thumbnails from occurring (e.g., when additional disk space is needed). And if a user of computer 110 views file search results including files from multiple directories, query results are not displayable as thumbnails.

Therefore, there is a need in the art for a thumbnail cache which honors file access privileges, allowing users to view only those thumbnails for files to which they have access. Further, there is a need for a thumbnail cache which can store thumbnails for files which may reside in read-only locations. There is also a need for a thumbnail cache which minimizes unnecessary duplication of thumbnail images in memory. Finally, there is a need for a thumbnail cache which allows for intelligent pruning of thumbnails, and which allows for the global display of thumbnail images independent of file location.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

A first illustrative embodiment provides a method for storing a thumbnail in a local thumbnail cache. A thumbnail image and identifying information (e.g., a modification timestamp, a file path, or even a CRC-64 hash of a string URL) are presented with a request to store the image. The image is stored in one of one or more data files, and the identifying information is stored in an index file accompanied by a location of the thumbnail within the data file.

A second illustrative embodiment provides a system for managing a thumbnail cache. The system includes storage for storing a data file and an index file. The system also includes a processor configured to receive a request to store a thumbnail image accompanied by identifying information associated with a file. The processor is also configured to store the thumbnail image in the data file, and store its location within the data file, along with the identifying information, in the index file.

### BRIEF DESCRIPTION OF THE DRAWINGS

The present invention is illustrated, by way of example and not limitation, in the accompanying figures in which like reference numerals indicate the same or similar elements and in which:

FIG. 1 is a functional block diagram of an operating environment that in which one or more aspects of an illustrative embodiment of the invention may be implemented;

FIGS. 2A and 2B depict prior art thumbnail caches;

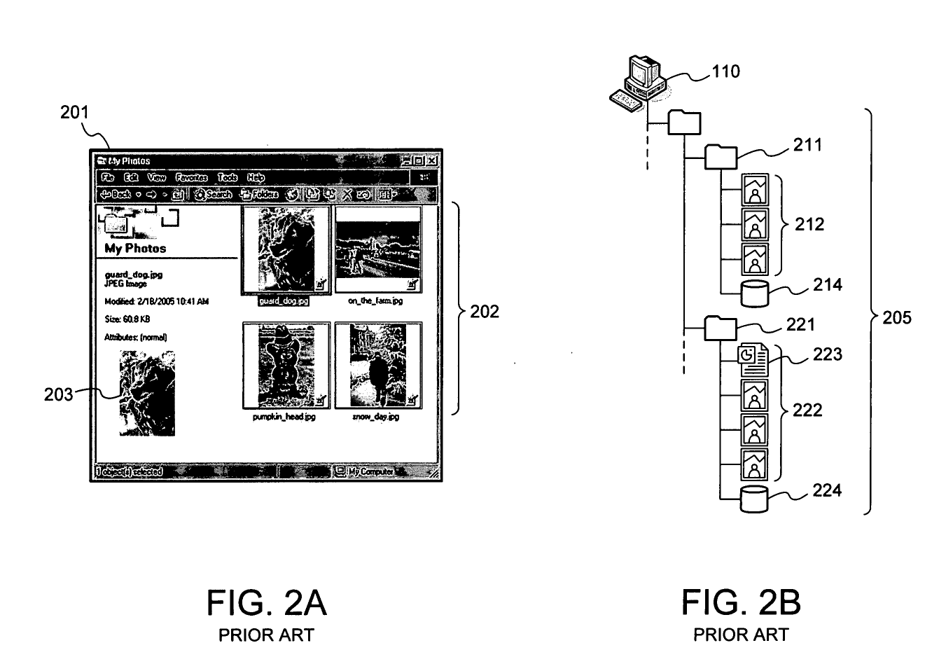

FIG. 3 depicts a block diagram of a local thumbnail cache according to one or more illustrative embodiments of the invention;

FIG. 4 illustrates a thumbnail cache index file with associated data files according to one or more illustrative embodiments of the invention;

FIG. 5 illustrates a process for storing a thumbnail in a thumbnail cache according to one or more illustrative embodiments of the invention; and

FIG. 6 illustrates a process for storing and retrieving a thumbnail with a thumbnail cache according to one or more illustrative embodiments of the invention.

### DETAILED DESCRIPTION OF THE DRAWINGS

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

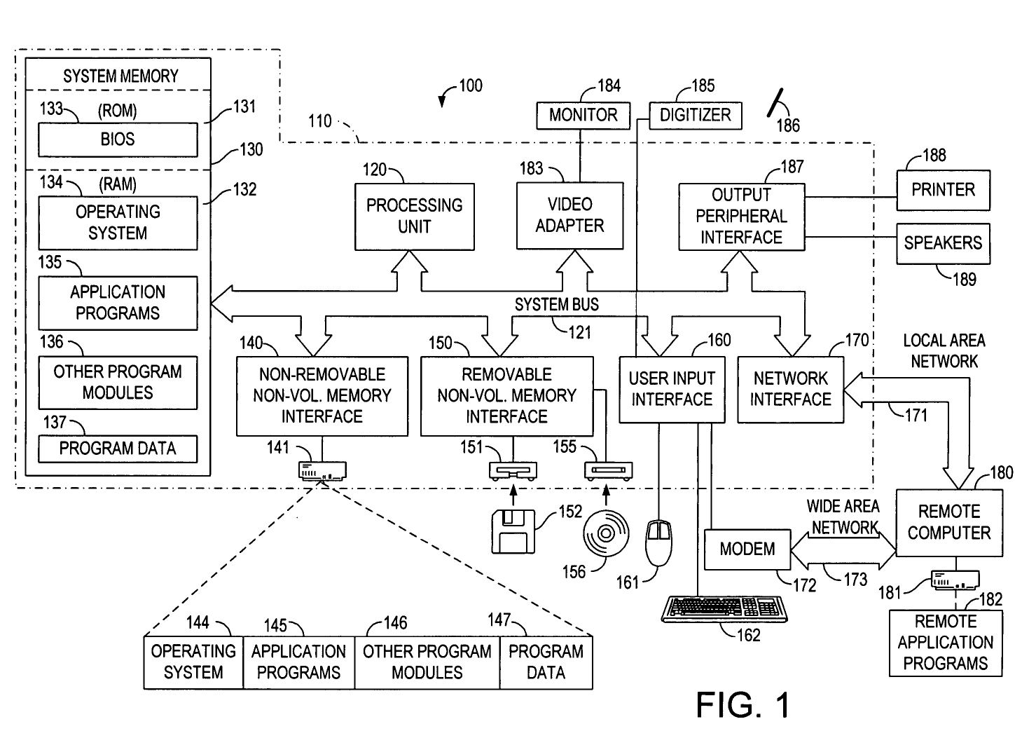

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should computing environment 100 be interpreted as having any dependency or requirement relating to any one or combination of components illustrated in illustrative operating environment 100.

Aspects of the invention may be operational with numerous other general purpose or special purpose computing system environments or configurations. Examples of well known computing systems, environments, and/or configurations that may be suitable for use with the invention include, but are not limited to, personal computers (PCs); server computers; hand-held and other portable devices such as personal digital assistants (PDAs), tablet PCs or laptop PCs; multiprocessor systems; microprocessor-based systems; gaming consoles; set top boxes; programmable consumer electronics; network PCs; minicomputers; mainframe computers; distributed computing environments that include any of the above systems or devices; and the like.

Aspects of the invention may be described in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

With reference to FIG. 1, illustrative computing system environment 100 includes a general purpose computing device in the form of a computer 110. Components of computer 110 may include, but are not limited to, a processing unit 120, a system memory 130, and a system bus 121 that couples various system components including system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Advanced Graphics Port (AGP) bus, and Peripheral Component Interconnect (PCI) bus, also known as Mezzanine bus.

Computer 110 typically includes a variety of computer readable media. Computer readable media may be any available media that can be accessed by computer 110 such as volatile, nonvolatile, removable, and non-removable media. By way of example, and not limitation, computer readable media may include computer storage media and communications media. Computer storage media may include volatile, nonvolatile, removable, and non-removable media implemented in any method or technology for storage of information such as computer-readable instructions, data structures, program modules or other data. Computer storage media includes, but is not limited to, random-access memory (RAM), read-only memory (ROM), electrically-erasable programmable ROM (EEPROM), flash memory or other memory technology, compact-disc ROM (CD-ROM), digital video disc (DVD) or other optical disk storage, magnetic cassettes, magnetic tape, magnetic disk storage or other magnetic storage devices, or any other medium which can be used to store the desired information and which can accessed by computer 110. Communications media typically embodies computer-readable instructions, data structures, program modules or other data in a modulated data signal such as a carrier wave or other transport mechanism and includes any information delivery media. By way of example, and not limitation, communications media includes wired media such as a wired network or direct-wired connection, and wireless media such as acoustic, radio frequency (RF) such as BLUETOOTH or Ultra-wide band (UWB) standard wireless links, infrared and other wireless media. Combinations of the any of the above should also be included within the scope of computer readable media.

The system memory 130 includes computer storage media in the form of volatile and/or nonvolatile memory such as ROM 131 and RAM 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates software including operating system 134, application programs 135, other program modules 136, and program data 137.

Computer 110 may also include other computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM, DVD, or other optical media. Other computer storage media that can be used in the illustrative operating environment include, but are not limited to, magnetic tape cassettes, flash memory cards, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer-readable instructions, data structures, program modules and other data for computer 110. In FIG. 1, for example, hard disk drive 141 is illustrated as storing an operating system 144, application programs 145, other program modules 146, and program data 147. Note that these components can either be the same as or different from operating system 134, application programs 135, other program modules 136, and program data 137, respectively. Operating system 144, application programs 145, other program modules 146, and program data 147 are given different numbers in FIG. 1 to illustrate that, at a minimum, they are different copies.

A user may enter commands and information into computer 110 through input devices such as a keyboard 162 and pointing device 161, commonly referred to as a mouse, trackball or touch pad. Each of these devices may include a plurality of input components, each providing its own input. In the case of a keyboard, each of the keys or specialized buttons may serve as input components. Moreover, a key combination may serve as a unique input component, such as a user modifying a key entry by holding a combination of the Control, Alt, Shift or other keys simultaneously. In the case of a mouse, trackball, or other pointing device, in addition to the position information each provides, input components may include the buttons, wheels, or other input mechanisms encased in the device.

Additional input devices (not shown) may include a microphone, joystick, game pad, scanner, or the like. These and other input devices are often coupled to processing unit 120 through a user input interface 160 that is coupled to system bus 121, but may be connected by other interface and bus structures, such as a parallel port, game port, universal serial bus (USB), or IEEE 1394 serial bus (FIREWIRE). A monitor 184 or other type of display device is also coupled to the system bus 121 via an interface, such as a video adapter 183. Video adapter 183 may comprise advanced 2D or 3D graphics capabilities, in addition to its own specialized processor and memory.

Computer 110 may also include a digitizer 185 to allow a user to provide input using a stylus 186. Digitizer 185 may either be integrated into monitor 184 or another display device, or be part of a separate device, such as a digitizer pad. Computer 110 may also include other peripheral output devices such as speakers 189 and a printer 188, which may be connected through an output peripheral interface 187.

Computer 110 may operate in a networked environment using logical connections to one or more remote computers, such as a remote computer 180. Remote computer 180 may be a personal computer, a server, a router, a satellite relay, a network PC, a peer device or other common network node, and typically includes many or all of the elements described above relative to computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, computer 110 is coupled to the LAN 171 through a network interface or adapter 170. When used in a WAN networking environment, computer 110 may include a modem 172, a satellite dish (not shown), or another device for establishing communications over WAN 173, such as the Internet.

Modem 172, which may be internal or external, may be connected to system bus 121 via user input interface 160 or another appropriate mechanism. In a networked environment, program modules depicted relative to computer 110, or portions thereof, may be stored remotely such as in remote storage device 181. By way of example, and not limitation, FIG. 1 illustrates remote application programs 182 as residing on memory device 181. It will be appreciated that the network connections shown are illustrative and other means of establishing a communications link between the computers may be used.

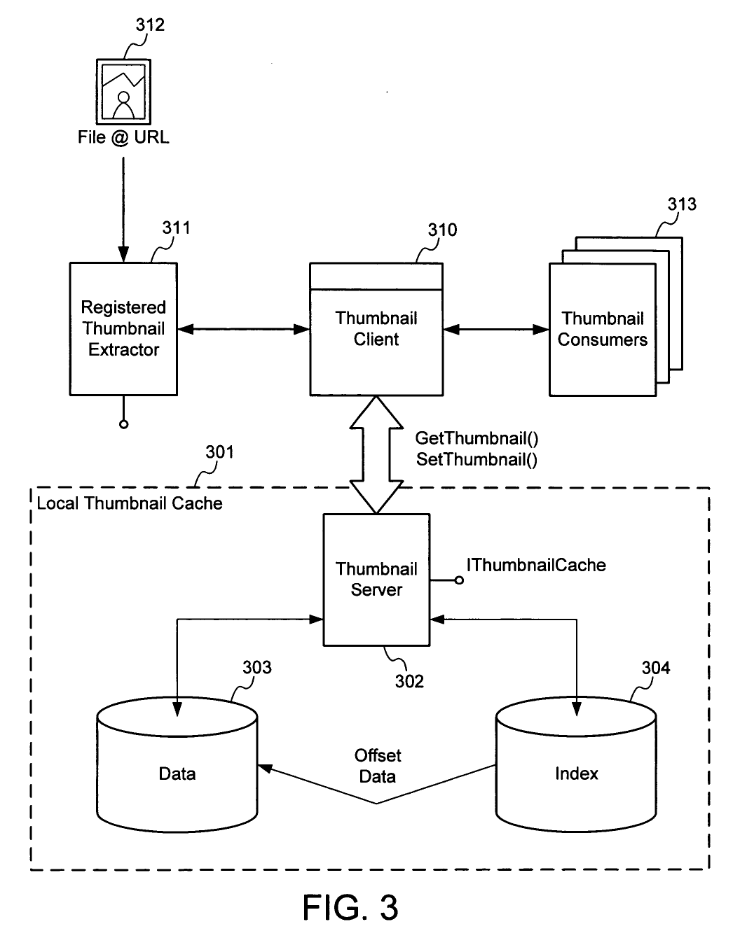

FIG. 3 depicts a block diagram of local thumbnail cache 301 according to one or more illustrative embodiments of the invention. Local thumbnail cache 301 may be part of a larger set of components associated with the generation, storage, and display of thumbnail images. These components may include thumbnail client 310, with which thumbnail consumers 313 may interact programmatically. Thumbnail consumers 313 may include components of operating system 134 (e.g., graphical file browsers) or third party software (e.g., graphics editing software). Thumbnail consumers 313 may request and retrieve thumbnails for particular files. Thumbnail client 310, upon receiving such a request, may either request generation of a thumbnail image (possibly as a background process), or may retrieve the image from local thumbnail cache 301.

Information associated with a particular file may be used as a “key” for storing and retrieving a thumbnail. This associated information may be described as “identifying information” in that it may be used to identify the location or properties of a particular file. Such information may include a name of the particular file, a location of the file (e.g., a uniform resource locator (URL) or file path), a modification timestamp, a creation timestamp, a file size, and so forth. Identifying information may further include a cryptographic hash of any of the above. For example, a URL associated with a file may be combined with a date and time of modification to form an identifying string from which a CRC-64 hash is extracted. Such identifying information may be used in indexing a thumbnail within local thumbnail cache 301.

For example, one of thumbnail consumers 313 may request a thumbnail image of file 312 from thumbnail client 310 by providing identifying information for the file (e.g., a URL and/or a date and time of modification). Using the identifying information as a lookup key, thumbnail client 310 may first consult local thumbnail cache 301 to see if file 312 already has a thumbnail image stored. If local thumbnail cache 301 does not have the thumbnail, then thumbnail client 310 may request that a registered thumbnail extractor 311 generate a thumbnail image for file 312. Once generated, thumbnail client 310 may reply to the consumer request with a copy of or a reference to the newly generated thumbnail. Thumbnail client 310 may also pass the new thumbnail on for storage in local thumbnail cache 301. Next time a thumbnail consumer requests a thumbnail for file 312, thumbnail client 310 may reply with a copy of or a reference to the image stored in local thumbnail cache 301 rather than waste processing time generating the thumbnail image anew.

Local thumbnail cache 301 is described as “local” because it is accessible only by the current recognized user. The term recognized user denotes a user of computer 110 who is recognized by the operating system 134. Although a computer may have many users, only recognized users may be granted control over the security of their files and control over their local settings. Recognized users typically have distinct login identifiers and passwords. Each recognized user may have access to his or her own set of local settings, which may include desktop preferences (e.g., background color) as well as security privileges (e.g., lock other users out of user files).

Local thumbnail cache 301 may be stored among a recognized user's local files. Each recognized user of computer 110 may be allotted his or her own local thumbnail cache 301. Although this may be duplicative, it prevents unfettered access to potentially sensitive files. As stated above, using globally accessible thumbnail caches may allow an unauthorized user access to a thumbnail image of a file to which he does not have access. By caching all thumbnails in a local cache which is only available to the recognized user, a potential security hole may be plugged. Various optimization schemes may streamline the thumbnail generating process. These schemes may include sharing thumbnails cached in other local or remote caches (while ensuring security measures are not thwarted). This caching scheme may be described as a per-user/per-machine cache since a separate cache is created for each recognized user of computer 110.

Local thumbnail cache 301 may include software code executable by processing unit 120, in the form of thumbnail server 302 coupled with a data store 303 and an index store 304. Data store 303 may include one or more data files containing thumbnail images stored as graphical information. Data store 303 may include only a single data file for storing all thumbnail images, regardless of image dimensions or file size. Alternatively, multiple data files may be used to store differently dimensioned thumbnails. Index store 304 may include an index file containing file identifying information coupled with locations (or location offsets) of associated thumbnails within data store 303. Index store 304 and data store 303 may be stored as separate files in operating system 134. Although separate files are described throughout, these files may be combined into a single federated cache file when stored in memory.

Thumbnail server 302 may be a collection of executable code implementing a particular thumbnail related programmatic interface. Thumbnail server 302 may be an executable file (e.g., thumbs.exe) or a dynamically linkable library of executable code (e.g., thumbcache.dll). The IThumbnailCache interface implemented by thumbnail server 302 may include two essential functions allowing thumbnail client 310 to get a thumbnail stored in the cache (e.g., GetThumbnail( )), and to put a thumbnail into the cache (e.g., SetThumbnail( )).

When thumbnail client 310 attempts to get a thumbnail image from local thumbnail cache 301, thumbnail client 310 may request it by supplying identifying information to thumbnail server 302. As noted above, this identifying information may include a URL, a date, a time, a hash of any of the above, and so forth. In addition, if local thumbnail cache 301 stores multiple sizes of thumbnail images, the identifying information may also include thumbnail dimensions (e.g., 32×32 or 128×128). If local thumbnail cache 301 does not have a thumbnail matching all of the identifying information, then cache 301 may return a cache miss indicator to thumbnail client 310.

If local thumbnail cache 301 has a stored copy of the requested thumbnail, it may return either a copy of the thumbnail image, or a reference to the image pointing directly into the cache. This may be referred to as “direct mapping.” Using a direct cache reference to a thumbnail image may avoid the creation of additional buffer copies of thumbnails, copies which must be managed (e.g., copies must be refreshed when the underlying thumbnail is modified). By supplying a reference to the thumbnail image as stored in the cache, video adapter 183 may be able to reference the thumbnail directly from the hard disk 141 depending on the memory management mechanisms employed by operating system 134.

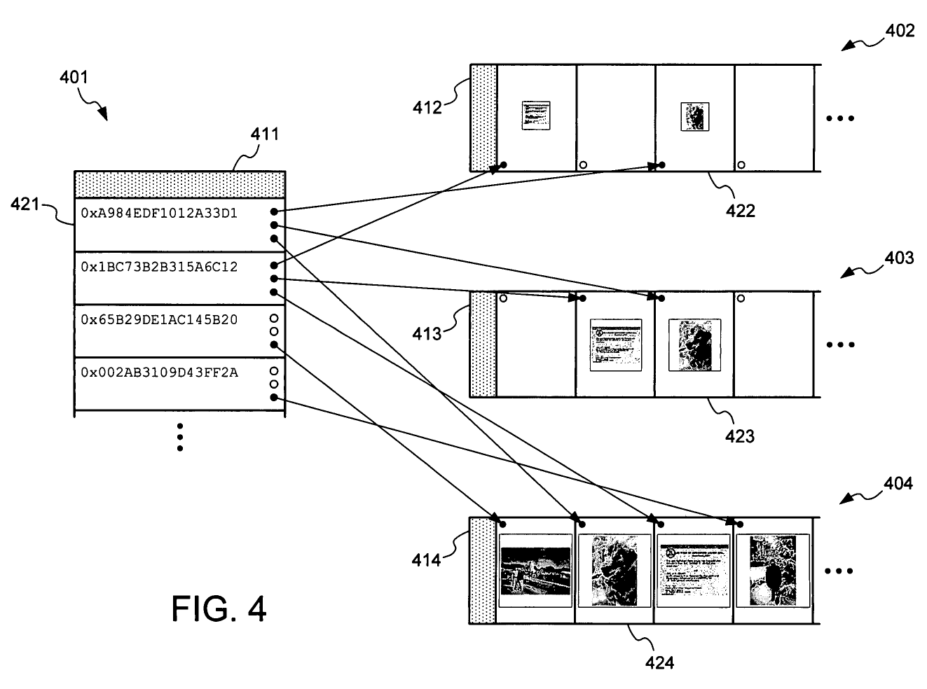

FIG. 4 illustrates a thumbnail cache index 401 with associated data files 402, 403, 404 according to one or more illustrative embodiments of the invention. Local thumbnail cache 301 may include an index 401. Index 401 may include a header 411 with information such as an index version number, as well as fields for managing read/write locks. Individual entries within index 401, for example index entry 421, may include identifying information (e.g., a generated hash of the URL string and/or a date and time of modification). In addition, each index entry may contain an array of location information, one array entry for each of the thumbnail data files which may contain a thumbnail. Index entries stored in index 401 may be stored using a hash table or scatter table for quick access. In particular, index entries may be stored in an open addressed scatter table with a linear probe sequence. Organization of index entries within index 401 may be tuned or optimized, increasing locality of the file, such that thumbnails frequently requested together may be stored in positions convenient to each other for quick access.

Local thumbnail cache 301 may include one or more associated data files 402, 403, 404, each containing thumbnails of a particular size or dimensions. Each data file may include a header 412, 413, 414 which may include information such as a data file version number, an associated thumbnail size (e.g., 32×32 or 128×128), as well as fields for managing orphan removal and read/write/maintainer locks. Using data files with a single thumbnail size may simplify coding, as serialized bitmaps (or other graphic formats) may require a standard size, making data file traversal and manipulation simpler. Thumbnail images which do not meet the exact pixel or file size requirements (e.g., have a different aspect ratio than a standard aspect ratio) may be padded in order to maintain a standard entry size. For example, the image may be padded in order to achieve a particular file size needed to allow direct mapping of the thumbnail.

Following headers 412, 413, 414 of data files 402, 403, 404, serialized versions of stored bitmaps (or JPEGs, or other graphic formats) may appear in each data file. Compressed formats may be used to store thumbnails, especially larger images. These compressed images may be uncompressed upon retrieval. Location information stored with each index entry of the index 401 may include offset information, providing a number of bytes or a number of images to count from a fixed starting point within each data file. Location information stored within each index entry of index 401 may additionally include a CRC-32 checksum (or similar checksum) of the contents of the thumbnail image. This may enable local thumbnail cache 301 to check if the contents of the thumbnail image have been inadvertently (or maliciously) modified since the image was stored.

Here is one possible example of a use of the thumbnail cache of FIG. 4. Index entry 421 includes location information for three thumbnails associated with the same identifying information. The value used as a key for the entry, “0xA984EDF1012A33D1,” may be a CRC-64 hash of the associated file location and/or modification date and time. The three data file entries 422, 423, 424 are thumbnails of the same image, but each is a different standardized size. When requesting a thumbnail associated with index entry 421, a requestor may indicate a particular size. Depending on which size is requested, thumbnail server 302 may search index 401 for index entry 421 using the identifying information, find the location information within the index entry corresponding with the requested thumbnail size, locate the thumbnail image in the appropriate data file using the location information, and then return a reference to or copy of the thumbnail image. Using CRC-64 hashes rather than identifying information as keys to the index entries, there is a possibility of a collision. Although rare, such collisions may be avoided by storing a copy of the identifying information with the thumbnail in a data file and comparing the information when a thumbnail is retrieved.

Local thumbnail cache 301 may be accessed via in-process server components of each client process. Rather than use a per-user or per-system broker service to arbitrate access to the thumbnail cache, individual client processes may cooperatively synchronize access to avoid contention when accessing the same files or memory space. Contention on index 401 may be low. A standard multiple readers/single writer group lock may be used to guard against contention in the index 401. Group lock implementation may be “writer-starved,” giving priority to reader locks. Contention on one or more data files 402, 403, 404 may be high. A readers/writer/maintainer lock may be used to avoid contention in data files 402, 403, 404. A maintainer may be allowed only to alter data file entries which cannot be accessed by readers (e.g., data file entry has been orphaned due to a moving index entry location) and may be allowed to “garbage collect” stale thumbnails as well as perform background scans and defragmentation passes.

Since local thumbnail cache 301 is a cache (as opposed to a database), a set of strategies for managing cache file size may be employed. No particular thumbnail image is guaranteed to remain in the cache for any period of time. Less used or out-of-date thumbnails may be thrown out on a regular basis to make room for new thumbnails. Strategies for managing cache size may include constraining each user's thumbnail cache (or all users' caches) to a particular size or percentage of available disk space; optionally allowing users to erase all thumbnail caches as part of a disk cleanup wizard; removing orphaned (unreferenced) data file entries by collecting “garbage”; and reclaiming space occupied by old and/or unused cache entries to be used by new thumbnails. Reclamation strategies may take into account the frequency of use, the time since last use, the size of the originally converted file, and so forth. For example, if an original file is larger (and takes longer to generate a thumbnail), then even if the original file is not frequently used, it may be more likely to remain in the cache and not be reclaimed.

In determining whether a particular thumbnail image is currently in use (and therefore is not garbage), conventional or unconventional approaches may be employed. One method for tracking whether a thumbnail is in use is to keep track of references to the thumbnail via a reference count, perhaps stored in shared memory with the index 401. Reference counts, however, may not be decremented by processes which terminate unexpectedly, preventing garbage collection of a now-orphaned thumbnail image.

One alternative method for tracking references to an image in a data file is to create uniquely named kernel objects for each thumbnail image being read. Cheap kernel objects (e.g., a mutex or an event) may be created when reading a thumbnail using, for example, a concatenation of a URL and a CRC-64 of an image name to name the kernel object. If a process dies while reading a thumbnail, the operating system will clean up the kernel object(s). When checking to see if a particular thumbnail is in use, the system simply queries the kernel for the unique name, or attempts to create the same object and sees if there is an error. So long as there is an error stating that the object already exists, the thumbnail is “in use.”

Reclamation algorithms may be employed to perform garbage collection (e.g. removing or overwriting thumbnail images no longer referenced by the index and no longer “in use”). Such algorithms may involve traversing the entirety of a data file (likely as a background process) searching for orphaned and not-in-use thumbnails. Orphaned thumbnails may immediately be replaced with new thumbnails, or they may be flagged for future reuse. Thumbnails within data files may include a header entry at the beginning of each stored image. This header may contain flags to indicate orphaned status. Alternatively, each stored image header may contain a value for a “next orphaned” data file entry. By walking a linked list of “next orphaned” entries, all orphaned thumbnail images may be discovered and dealt with in turn. Additionally, defragmentation passes may remove orphaned thumbnail images from a data file entirely, shifting referenced thumbnails in to close the gaps. These passes may also rearrange the images for better locality based on usage statistics, like a continuously updated histogram of use count over time.

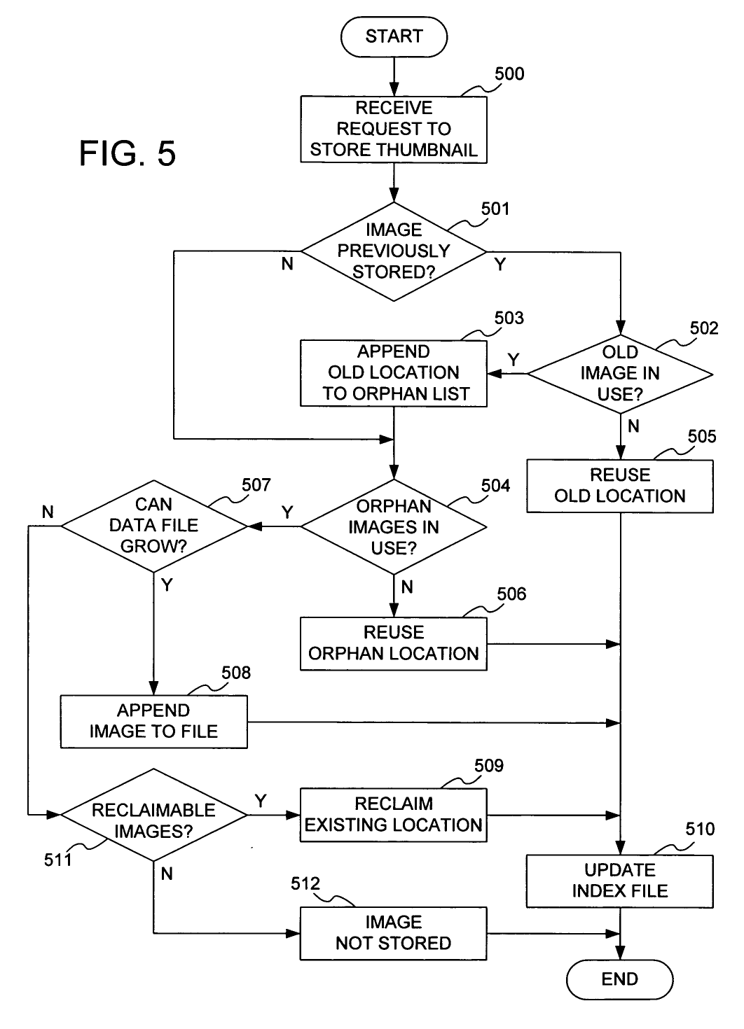

FIG. 5 depicts a process for storing a thumbnail image in local thumbnail cache 301 suggested by the reclamation strategies described above. At step 500, a request to store a thumbnail image is received, accompanied by identifying information. The index 401 is checked at decision 501 to see if an image has been previously stored in this thumbnail size using the same identifying information. If an image has previously been stored, then at decision 502, the old image is checked to see if it is currently in use. If it is in use, then at step 503, the location of the previously-stored image is stored in a list of orphaned locations to be cleaned-up later. If the image is not presently in use, then at step 505, the location is reused for the new image. After step 503 or if at decision 501, the image was not previously stored, the list of orphans is checked to see if any are not currently in use at decision 504. If there is an orphan not-in-use, then at step 506, the orphan's location is used for the new image providing the orphan's image size is large enough to accommodate the replacement image. If there are no available orphans, then at decision 507, the data file is inspected to see if it can grow given the constraints discussed above. If the data file can grow, then at step 508, the new image is appended to the data file. If the data file cannot grow further, then at decision 511, the reclamation strategies discussed above are put to use to select a non-orphaned but not in-use image to reclaim. If no images can be found then the new image is not stored by the cache at step 512. If reclaimable images are found, then at step 509, the storage location is reclaimed and the new image replaces the selected reclaimable image. If a new image is stored by any of the above steps (505, 506, 508, or 509), then at step 510, the new location of the image is used to update the entry in index 401.

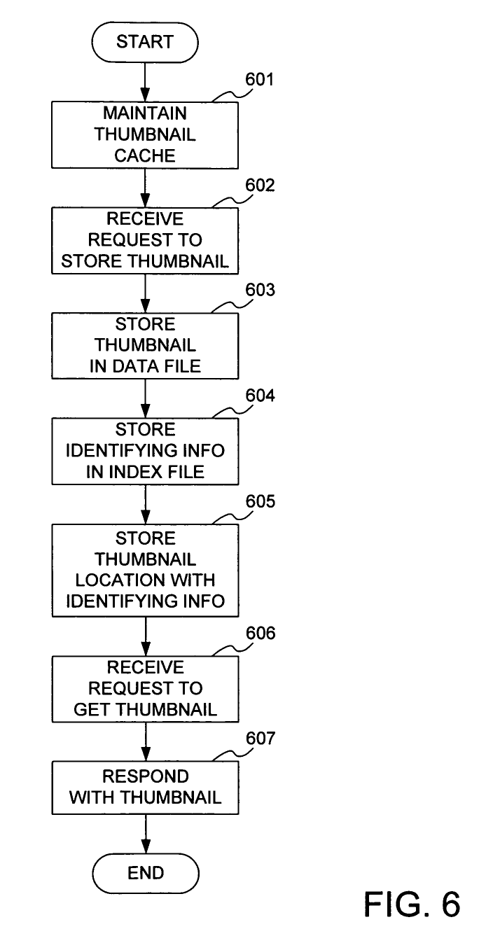

FIG. 6 depicts a general process for storing and retrieving a thumbnail from local thumbnail cache 301. At step 601, local thumbnail cache 301 is maintained using an index 401 and one or more data files. At step 602, a request to store a thumbnail is received accompanied by identifying information. At step 603, the thumbnail image is stored in a data file, possibly using the process outlined above. At step 604, the identifying information is stored in the index 401, and at step 605, the location of the image within the data file is stored with the identifying information in the index 401. At step 606, a request to retrieve the thumbnail image, as indicated by its identifying information, is received. At step 607, using a process outlined above, the image or a reference to it is retrieved.

While aspects of the invention have been described with respect to specific examples, including presently preferred modes of carrying out the invention, those skilled in the art will appreciate that there are numerous variations and permutations of the above described systems and techniques that fall within the spirit and scope of the invention as set forth in the appended claims.

We claim:

1. A computer-implemented method for managing thumbnail images, the method comprising:
maintaining a thumbnail cache in a computer, the thumbnail cache including an index and a data store;
receiving a first request to add a thumbnail image to the thumbnail cache, the first request including the thumbnail image, identifying information, and a thumbnail size;
storing the thumbnail image in the data store; and
storing in the index the identifying information, the thumbnail size, and a location of the thumbnail image within the data store.

2. The method of claim 1 wherein the identifying information includes a file location and a modification time.

3. The method of claim 1, further comprising:
receiving a second request to retrieve the thumbnail image, the second request including the identifying information and the thumbnail size; and
replying to the second request with the thumbnail image.

4. The method of claim 3, further comprising:
displaying the thumbnail image on a display, a memory associated with the display reading an uncompressed copy of the thumbnail image directly from the thumbnail cache.

5. The method of claim 1, wherein:
the data store includes a plurality of data files, one data file for each of a plurality of different thumbnail sizes; and
an entry in the index includes the identifying information and a plurality of thumbnail image locations within the plurality of data files.

6. The method of claim 1, wherein each recognized user of the computer has a dedicated thumbnail cache.

7. The method of claim 6, wherein each dedicated thumbnail cache is accessible only by the corresponding recognized user.

8. The method of claim 1, wherein the thumbnail cache is simultaneously accessible by a plurality of processes running on the computer.

9. The method of claim 8, wherein the plurality of processes cooperatively synchronize their access to the thumbnail cache.

10. The method of claim 1, wherein storing the thumbnail image in the data store comprises:
determining whether an old thumbnail image associated with the identifying information already exists in a location in the data store; and
responsive to the old thumbnail image existing in the data store, storing the thumbnail image in the location of the old thumbnail image.

11. A system for managing thumbnail images, the system comprising:
a storage for storing a thumbnail cache, the thumbnail cache including an index file and one or more data files; and
a processor configured to:
receive a first request to store a thumbnail image in the thumbnail cache, the first request including the thumbnail image and identifying information;
store in one of the one or more data files the thumbnail image;
store in the index the identifying information and a location of the thumbnail image within the one of the one or more data files.
receive a second request to retrieve the thumbnail image, the second request including the identifying information; and
reply to the second request with a reference to the thumbnail image.

12. The system of claim 11, wherein the identifying information includes a file location and a date and time of modification.

13. The system of claim 12, wherein the file location is a uniform resource locator.

14. The system of claim 10, further comprising:
a display; and
a memory, wherein the reference to the thumbnail image points to a memory location within the memory where a representation of the thumbnail image is located, and wherein the processor is further configured to display the thumbnail image on the display by directly referencing the memory location.

15. The system of claim 11, wherein the processor is further configured to:
determine whether an older thumbnail image was previously stored in a memory location for the identifying information;
responsive to the older thumbnail image having been previously stored, reuse the memory location of the older thumbnail image within the one of the one or more data files to store the thumbnail image.

16. The system of claim 11, wherein a recognized user of the system has a dedicated thumbnail cache.

17. The system of claim 11, wherein the thumbnail cache is simultaneously accessible by multiple processes running on the computer.

18. The system of claim 11, wherein:
the thumbnail cache comprises a plurality of data files, one data file for each of a plurality of different thumbnail image sizes;
an entry in the index file includes the identifying information and one or more thumbnail image locations within the plurality of data files; and
the first request further includes an indicator of one of the plurality of different thumbnail image sizes.

19. A system for managing thumbnail images, the system comprising:
a display;
a storage for storing a thumbnail cache, the thumbnail cache including an index file and a plurality of data files; and
a processor configured to:
receive a first request to store a thumbnail image in the thumbnail cache, the first request including the thumbnail image, a file location, a date and time of modification, and a thumbnail size;
store the thumbnail image in one of the plurality of data files;
store in the index file the file location, the date and time of modification, and the thumbnail size of the thumbnail image within the one of the plurality of data files.
receive a second request to retrieve the thumbnail image, the second request comprising the file location, the date and time of modification, and the thumbnail size;
reply to the second request with a reference to the thumbnail image; and
display the thumbnail image on the display.

20. The system of claim 18, further comprising:
a video adapter, wherein the video adapter directly reads the thumbnail image from the thumbnail cache.
